(19) United States
(12) Patent Application Publication
(10) Pub. No.: US 2014/0145973 A1
(43) Pub. Date: May 29, 2014

(54) TOUCH SCREEN MODULE AND METHOD OF MANUFACTURING THE SAME

(71) Applicant: SAMSUNG ELECTRO-MECHANICS CO., LTD., Suwon (KR)

(72) Inventors: Kee Su JEON, Suwon (KR); Tae Hoon KIM, Suwon (KR)

(73) Assignee: SAMSUNG ELECTRO-MECHANICS CO., LTD., Suwon (KR)

(21) Appl. No.: 13/755,474

(22) Filed: Jan. 31, 2013

(30) Foreign Application Priority Data
Nov. 23, 2012 (KR) 10-2012-0133608

(51) Int. Cl. G06F 3/041

(52) U.S. Cl. CPC G06F 3/041
USPC 345/173; 427/58; 427/123; 427/125; 427/126.2; 427/122

(57) ABSTRACT

There is provided a touch screen module including a glass substrate, a first photosensitive resin layer formed on the glass substrate and a bezel including a second photosensitive resin layer formed on the first photosensitive resin layer, and transparent electrodes simultaneously formed on both the glass substrate and the bezel. A residue phenomenon in which pigment particles included in the bezel remain on a surface of the glass substrate after exposure and development may be prevented.

### CROSS-REFERENCE TO RELATED APPLICATIONS

This application claims the priority of Korean Patent Application No. 10-2012-0133608 filed on Nov. 23, 2012, in the Korean Intellectual Property Office, the disclosure of which is incorporated herein by reference.

### BACKGROUND OF THE INVENTION

1. Field of the Invention

The present invention relates to a touch screen module and a method of manufacturing the same.

2. Description of the Related Art

In accordance with the continuous development of electronics technology and information technology, the uptake rate of electronic devices in everyday life, including the workplace, has gradually increased. Particularly, in accordance with the continuous development of electronics technology, a touch screen module (TSM) has been used in portable devices that have tended to be increasingly miniaturized and thinned.

The touch screen module, an apparatus generally installed in a display apparatus to sense a location of a screen touched by a user and performing controlling of an electronic device including screen controlling of a display using information on the sensed touch location as input information, has various advantages such as a simple configuration, low malfunction rate, compactness, easy interworking with information technology (IT) devices, and the like.

Meanwhile, several types of touch screen modules such as a resistive-type touch screen module, a capacitive-type touch screen module, an electromagnetic-type touch screen module, a surface acoustic wave (SAW)-type touch screen module, and an infrared-type touch screen module have been used. Among them, resistive-type touch screen modules and the capacitive-type touch screen modules have mainly been used in view of both functionality and economy.

Particularly, an operation type of the touch screen module has been recently changed rapidly from the resistive-type to the capacitive-type, and the touch screen module has also been changed to a window integrated touch screen module.

In the window integrated touch screen module, after a bezel is coated, a sensor electrode is coated. However, since the sensor electrode is very thin, a step should be decreased and a thickness of the bezel should be thin in order to prevent a defect in which the electrode is disconnected at an edge of the bezel. Therefore, in order to allow the bezel to be thin and form patterns, there is a need to produce ink containing composition components having photosensitivity.

In addition, the ink should contain a specific pigment in addition to the photosensitive components in order to represent a specific color. However, after the ink is coated, exposed, and developed, a residue phenomenon in which pigment particles remain on a glass substrate occurs. These residue particles hinder formation and an operation of the sensor electrode.

### RELATED ART DOCUMENT

Korean Patent Laid-open Publication No. 2012-0066272
Korean Patent Laid-open Publication No. 2011-0125451

### SUMMARY OF THE INVENTION

An aspect of the present invention provides a touch screen module in which a bezel having a specific color is formed on a glass substrate, particularly, a thin photosensitive resin layer is formed before photosensitive ink including a pigment is coated in order to prevent residue from a pigment particle, and a method of manufacturing the same.

According to an aspect of the present invention, there is provided a touch screen module including: a glass substrate; a first photosensitive resin layer formed on the glass substrate and a bezel including a second photosensitive resin layer formed on the first photosensitive resin layer; and transparent electrodes simultaneously formed on both the glass substrate and the bezel.

The transparent electrode may include at least one selected from a group consisting of silver (Ag), gold (Au), copper (Cu), aluminum (Al), indium tin oxide (ITO), and a conductive polymer.

The silver (Ag) may be a silver salt including gelatin.

The first photosensitive resin layer may be formed by a spin coating method or a slit coating method.

The second photosensitive resin layer may be formed by the spin coating method or the slit coating method.

The second photosensitive resin layer may include a pigment.

The pigment may be titanium dioxide (TiO₂) or carbon black.

According to another aspect of the present invention, there is provided a method of manufacturing a touch screen module, the method including: preparing a glass substrate; forming a first photosensitive resin layer on the glass substrate and forming a bezel including a second photosensitive resin layer on the first photosensitive resin layer; and simultaneously forming transparent electrodes on both the glass substrate and the bezel.

The transparent electrode may include at least one selected from a group consisting of silver (Ag), gold (Au), copper (Cu), aluminum (Al), indium tin oxide (ITO), and a conductive polymer.

The silver (Ag) may be a silver salt including gelatin.

The first photosensitive resin layer may be formed by a spin coating method or a slit coating method.

The second photosensitive resin layer may be formed by the spin coating method or the slit coating method.

The second photosensitive resin layer may include a pigment.

The pigment may be titanium dioxide (TiO₂) or carbon black.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a touch screen module according to an embodiment of the present invention;

FIG. 2 is a cross-sectional view providing a process of manufacturing a glass substrate according to the embodiment of the present invention;

FIG. 3 is a view showing a result obtained by observing a surface of the touch screen module according to the embodiment of the present invention using a scanning electronic microscope (SEM) photograph; and

FIG. 4 is a view showing a result obtained by observing a surface of a touch screen module according to Comparative Example of the present invention using an SEM photograph.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

Meanwhile, although a touch screen module will be described as an example in which a glass substrate is applied in the present embodiment, the present invention is not limited thereto. That is, the glass substrate according to the present embodiment may also be applied to a solar cell, a display device, or the like.

### Structure of Touch Screen Module 100

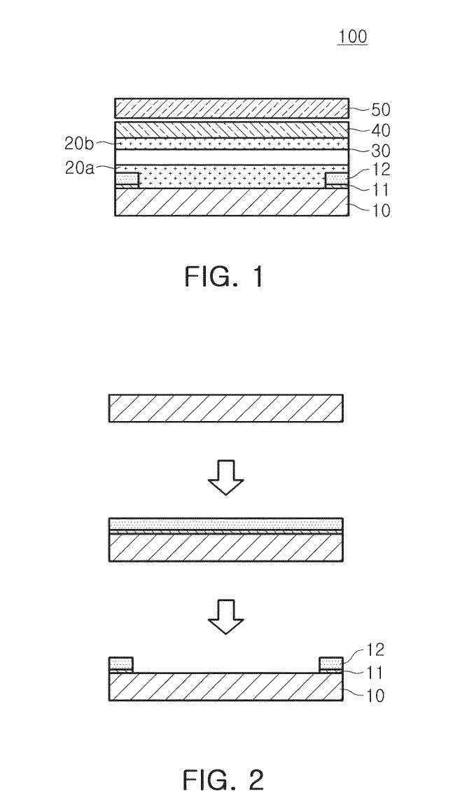

FIG. 1 is a cross-sectional view of a touch screen module 100. Hereinafter, the touch screen module 100 according to the present embodiment will be described with reference to FIG. 1.

As shown in FIG. 1, the touch screen module 100 according to the present embodiment may include a glass substrate 10 including a first photosensitive resin layer 11 and a bezel 12, transparent electrodes 20a and 20b, an insulating layer 30, an optically clear adhesive (OCA) 40, and a display 50. The bezel 12 may include a second photosensitive resin layer.

The glass substrate 10 may be a member providing a space on which the transparent electrodes 20a and 20b are formed.

Here, the glass substrate 10 may be formed of a material having a high degree of durability so as to sufficiently protect other components of the glass substrate 10 from external force. In addition, the glass substrate 10 may be formed of a transparent material so that an image from the display 50 may be clearly transferred to a user.

The transparent electrodes 20a and 20b may be members formed on the glass substrate 10 to sense several electrical signals.

Here, in the case in which the glass substrate 10 is used in the touch screen module 100, the transparent electrodes 20a and 20b may sense an input signal. For example, in the case of a capacitive-type touch screen module 100, the transparent electrodes 20a and 20b may measure parasitic capacitance from the input and sense a change in capacitance to transfer the measured parasitic capacitance and the sensed change in capacitance to a controlling unit, and the controlling unit may recognize coordinates of a pressed position to implement a required operation. More specifically, after a voltage is applied to spread a high frequency over the entire surfaces of the transparent electrodes 20a and 20b, when the input is generated, the transparent electrodes 20a and 20b may act as electrodes and the glass substrate 10 may act as a dielectric, such that a predetermined change in capacitance is generated, and the controlling unit may sense the changed waveform to recognize a position of the input, whether or not the input has been generated, or the like.

The optically clear adhesive 40 may be a member formed between the insulating layer 30 and the display 50 to adhere the insulating layer 30 and the display 50 to each other.

### Method of Manufacturing Glass Substrate 10

FIG. 2 is a cross-sectional view of a process of manufacturing a glass substrate 10 according to the embodiment of the present invention. Hereinafter, a method of manufacturing a glass substrate 10 according to the embodiment of the present invention will be described with reference to FIG. 2.

First, as shown in FIG. 2, the glass substrate 10 is prepared. The first photosensitive resin layer 11 is formed on the glass substrate 10 by, for example, a spin coating method or a slit coating method.

Next, the bezel 12 including the second photosensitive resin layer may be formed on the first photosensitive resin layer 11 by a spin coating method or a slit coating method.

According to the related art, a screen printing method has mainly been used. This method may be mainly used to manufacture a relatively thick bezel 12. Therefore, in order to manufacture a relatively thin bezel 12, the spin coating method or the slit coating method may be used.

Therefore, after the first photosensitive resin layer 11 is formed on the glass substrate 10 and the bezel 12 including the second photosensitive resin layer is formed on the first photosensitive resin layer 11, the glass substrate 10 to be included in the touch screen module 100 is prepared through exposure or development.

### Photosensitive Resin Composition

In the case in which force acting between particles and a surface of the glass substrate 10 in the touch screen module 100 is relatively strong, since it is likely that the particles will remain on the surface of the glass substrate 10 even after the exposure or the development, the thin first photosensitive resin layer 11 is formed on the glass substrate 10 in order to fundamentally prevent residue from the particles.

The photosensitive resin composition may contain (a) a binder resin, (b) a photopolymerizable compound, (c) a photopolymerizable-photopolymerization initiator, and (d) a solvent.

In addition, the first photosensitive resin layer 11 is coated, heat is applied thereto to remove a solvent, and the bezel 12 including the second photosensitive resin layer is then formed, wherein the second photosensitive resin layer may further contain a pigment.

That is, the second photosensitive resin layer may be formed by agitating a dispersing liquid in the photosensitive resin composition, wherein the dispersing liquid may contain (a) a binder resin, (d) a solvent, (e) a coloring agent, and (f) a dispersant. In addition, the dispersing liquid may further contain (g) an additive agent.

### (a) Binder Resin

The binder resin is not particularly limited, but may be any binder resin generally used in the art.

The binder resin is not particularly limited, but may be any kind of resin that may be dissolved in the solvent according to the embodiment of the present invention, function as a binding resin for the coloring agent, and be dissolved in an alkaline developer.

Examples of the binder resin may include a carboxyl group-containing monomer, a copolymer with another monomer capable of being copolymerized with the carboxyl group containing monomer, or the like.

Examples of the carboxyl group-containing monomer may include an unsaturated carboxylic acid such as an unsaturated polycarboxylic acid, or the like, having at least one carboxylic acid in molecules such as an unsaturated monocarboxylic acid, an unsaturated dicarboxylic acid, an unsaturated tricarboxylic acid, and the like.

Examples of the unsaturated monocarboxylic acid may include an acrylic acid, a methacrylic acid, a crotonic acid, an α-chloroacrylic acid, a cinnamic acid, or the like.

Examples of the unsaturated dicarboxylic acid may include a maleic acid, a fumaric acid, an itaconic acid, a citraconic acid, a mesacon acid, or the like.

The unsaturated polycarboxylic acid may be acid anhydride. More specifically, the unsaturated polycarboxylic acid may be maleic anhydride, itaconic anhydride, citraconic anhydride, or the like. In addition, the unsaturated polycarboxylic acid may be a mono(2-methacryloyloxyalkyl) ester thereof. For example, the unsaturated polycarboxylic acid may be succinic acid mono(2-acryloyloxyethyl), succinic acid mono(2-methacryloyloxyethyl), phthalic acid mono(2-acryloyloxyethyl), phthalic acid mono(2-methacryloyloxyethyl), or the like. The unsaturated polycarboxylic acid may also be mono(metha) acrylate having dicarboxylic polymers at both terminals thereof. For example, the unsaturated polycarboxylic acid may be ω-carboxypolycaprolactonemonoacrylate, ω-carboxypolycaprolactonemonomethacrylate, or the like.

Each of the carboxyl group-containing monomers may be used alone or as a mixture of two or more of the carboxyl group-containing monomers.

Examples of another monomer capable of being copolymerized with the carboxyl group containing monomer may include aromatic vinyl compounds such as styrene, α-methylstyrene, o-vinyltoluene, m-vinyltoluene, p-vinyltoluene, p-chlorostyrene, o-methoxystyrene, m-methoxystyrene, p-methoxystyrene, o-vinylbenzylmethylether, m-vinylbenzylmethylether, p-vinylbenzylmethylether, o-vinylbenzylglycidylether, m-vinylbenzylglycidylether, p-vinylbenzylglycidylether, indene, or the like; unsaturated carboxylic acid esters such as methylacrylate, methylmethacrylate, ethylacrylate, ethylmethacrylate, n-propylacrylate, n-propylmethacrylate, i-propylacrylate, i-propylmethacrylate, n-butylacrylate, n-butylmethacrylate, i-butylacrylate, i-butylmethacrylate, sec-butylacrylate, sec-butylmethacrylate, t-butylacrylate, t-butylmethacrylate, 2-hydroxyethylacrylate, 2-hydroxyethylmethacrylate, 2-hydroxypropylacrylate, 2-hydroxypropylmethacrylate, 3-hydroxypropylacrylate, 3-hydroxypropylmethacrylate, 2-hydroxybutylacrylate, 2-hydroxybutylmethacrylate, 3-hydroxybutylacrylate, 3-hydroxybutylmethacrylate, 4-hydroxybutylacrylate, 4-hydroxybutylmethacrylate, arylacrylate, arylmethacrylate, benzylacrylate, benzylmethacrylate, cyclohexylacrylate, cyclohexylmethacrylate, phenylacrylate, phenylmethacrylate, 2-methoxyethylacrylate, 2-methoxyethylmethacrylate, 2-phenoxyethylacrylate, 2-phenoxyethylmethacrylate, methoxydiethyleneglycolacrylate, methoxydiethyleneglycolmethacrylate, methoxytriethyleneglycolacrylate, methoxytriethyleneglycolmethacrylicacrylate, methoxypropyleneglycolacrylate, methoxypropyleneglycolmethacrylate, methoxydipropyleneglycolacrylate, methoxydipropyleneglycolmethacrylate, isobornylacrylate, isobornylmethacrylate, dicyclopentadienylacrylate, dicyclopentadiethylmethacrylate, 2-hydroxy-3-phenoxypropylacrylate, 2-hydroxy-3-phenoxypropylmethacrylate, glycerolmonoacrylate, glycerolmonomethacrylate, or the like; unsaturated carboxylic acid aminoalkyl esters such as 2-aminoethylacrylate, 2-aminoethylmethacrylate, 2-dimethylaminoethylacrylate, 2-dimethylaminoethylmethacrylate, 2-aminopropylacrylate, 2-aminopropylmethacrylate, 2-dimethylaminopropylacrylate, 2-dimethylaminopropylmethacrylate, 3-aminopropylacrylate, 3-aminopropylmethacrylate, 3-dimethylaminopropylacrylate, 3-dimethylaminopropylmethacrylate, or the like; unsaturated carboxylic acid glycidyl ester such as glycidylacrylate, glycidylmethacrylate, or the like; carboxylic acid vinylester such as vinylacetate, vinylpropionate, vinylbutyrate, vinylbenzoate, or the like; unsaturated ethers such as vinylmethylether, vinylethylether, allylglycidylether, or the like; vinyl cyanide compounds such as acrylonitrile, methacrylonitrile, α-chloroacrylonitrile, vinylidenecyanide, or the like; unsaturated amides such as acrylamide, methacrylamide, α-chloroacrylamide, N-2-hydroxyethylacrylamide, N-2-hydroxyethylmethacrylamide, or the like; unsaturated imides such as maleimide, N-phenylmaleimide, N-cyclohexylmaleimide, or the like; aliphatic conjugated diene such as 1,3-butadiene, isoprene, chloroprene, or the like; and macromonomers having monoacryloyl group or monomethacryloyol group at terminals of polymer molecular chains of polystyrene, polymethylacrylate, polymethylmethacrylate, poly-n-butyl acrylate, poly-n-butylmethacrylate, and polysiloxane; or the like. Each of these monomers may be used alone or as a mixture of two or more thereof.

In the case in which the binder resin is the copolymer of the carboxyl group-containing monomer and another monomer copolymerizable with the carboxyl group-containing monomer, a content ratio in a configuration unit derived from the carboxyl group-containing monomer may be 10 to 50 mass % with respect to a total content of configuration units configuring the copolymer. When the content ratio in a configuration unit derived from the carboxyl group-containing monomer is 10 to 50 mass % with respect to the total content of configuration units configuring the copolymer, solubility thereof for a developer may be good and a pattern may be accurately formed at the time of development. In addition, an acid value may be in a range of 70 mgKOH/g to 120 mgKOH/g.

Examples of the binder resin may include a(meth)acrylic acid/methyl(meth)acrylate copolymer, a(meth)acrylic acid/benzyl(meth)acrylate copolymer, a(meth)acrylic acid/2-hydroxy ethyl(meth)acrylicrate/benzyl(meth)acrylate copolymer, a(meth)acrylic acid/methyl(meth)acrylate/polystyrenemacromonomer copolymer, a(meth)acrylic acid/methyl(meth)acrylate/polymethyl(meth)acrylatemacromono mer copolymer, a(meth)acrylic acid/benzyl(meth)acrylate/polystyrenemacromonomer copolymer, a(meth)acrylic acid/benzyl(meth)acrylate/polymethyl(meth)acrylatemacromono mer copolymer, a(metha)acrylic acid/2-hydroxyethyl(meth)acrylate/benzyl(meth)acrylate/poly styrenemacromonomer copolymer, a(meth)acrylic acid/2-hydroxyethyl(meth)acrylate/benzyl(meth)acrylate/poly methyl(meth)acrylatemacromonomer copolymer, a(metha)acrylic acid/styrene/benzyl(meth)acrylate/N-phenylmaleimide copolymer, a(meth)acrylic acid/mono(2-acryloyloxy)succinic acid/styrene/benzyl(meth)acrylate/N-phenylmaleimide copolymer, a(meth)acrylic acid/mono(2-acryloyloxyethyl)succinic acid/styrene/allyl(meth)acrylate/N-phenylmaleimide copolymer, a(meth)acrylic acid/benzyl(meth)acrylate/N-phenylmaleimide/styrene/glycero lmono(meth)acrylate copolymer, or the like.

Among them, the (meth)acrylic acid/benzy(meth)acrylate copolymer, the (meth)acrylic acid/benzyl(meth)acrylate/styrene copolymer, the (meth)acrylic acid/methy(meth)acrylate copolymer, the (meth)acrylic acid/methy(meth)acrylate/styrene copolymer may be used.

A weight-average molecular weight of the binder resin converted as polystyrene may be in a range of 3,000 to 100,000, but is not particularly limited thereto. When the weight-average molecular weight of the binder resin is in the range of 3,000 to 100,000, the coloring agent may be easily dispersed, viscosity may be relatively low, and storage stability may be excellent.

A content of the binder resin may be in a range of 3 to 80 mass % as a mass fraction with respect to a solid content in a coloring agent dispersing composition. When the content of the binder resin is in the range of 3 to 80 mass % with respect to the solid content in the coloring agent dispersing composition, the coloring agent may be easily dispersed, and storage stability may be excellent.

### (b) Photopolymerizable Compound

As the photopolymerizable compound, a compound polymerizable by an action of light and a photopolymerization initiator, a mono-functional monomer, a bi-functional monomer, a poly-functional monomer, or the like, may be used.

Specific examples of the mono-functional monomer may include nonylphenylcarbitolacrylate, 2-hydroxy-3-phenoxypropylacrylate, 2-ethylhexylcarbitolacrylate, 2-hydroxyethylacrylate, N-vinylpyrrolidone, or the like.

Specific examples of the bi-functional monomer may include 1,6-hexanedioldi(meth)acrylate, ethyleneglycoldi(meth)acrylate, neopentylglycoldi(meth)acrylate, triethyleneglycoldi(meth)acrylate, bis(acryloyloxyethyl)ether of bisphenol A, 3-methylpentanedioldi(meth)acrylate, or the like.

Specific examples of the polyfunctional photopolymer compounds having a functionality of three or more may include trimethylolpropane tri(meth)acrylate, ethoxylatetrimethylolpropanetri(meth)acrylate, propoxylatetrimethylolpropanetri(meth)acrylate, pentaerythritoltri(meth)acrylate, pentaerythritoltetra(meth)acrylate, dipentaerythritolpenta(meth)acrylate, ethoxylatedipentaerythritolhexa(meth)acrylate, propoxylatedipentaarythritolhexa(meth)acrylate, dipentaerythritolhexa(meth)acrylate, or the like.

Among the photopolymerizable compounds as described above, (meth)acrylic acid esters and urethane(meth)acrylate having a functionality of three or more may be particularly used in that it has excellent polymerization and may improve strength.

Each of the photopolymerizable compounds as described above may be used alone or as a mixture of two or more thereof.

### (c) Photopolymerization Initiator

As the photopolymerization initiator, at least one selected from a group consisting of a triazine based compound, an acetophenone based compound, a biimidazole based compound, and an oxime compound may be used.

Specific examples of the triazine based compound may include 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-piperonyl-1,3,5-triazine, 2,4-bis(trichloromethyl)-6-(4-methoxystyryl)-1,3,5-triazine, 2,4-bis(trichloromethyl)-6-[2-(5-methylfuran-2-yl)ethenyl]-1,3,5-triazine, 2,4-bis(trichloromethyl)-6-[2-(furan-2-yl)ethenyl]-1,3,5-triazine, 2,4-bis(trichloromethyl)-6-[2-(4-diethylamino-2-methylpheny 1)ethenyl]-1,3,5,-triazine, 2,4-bis(trichloromethyl)-6-[2-(3,4-dimethoxyphenyl)ethenyl]-1,3,5-triazine, or the like.

Specific examples of the acetophenone based compound may include diethoxy acetophenone, 2-hydroxy-2-methyl-1-phenylpropane-1-on, benzyl dimethyl ketal, 2-hydroxy-1-[4-(2-hydroxyethoxy)phenyl]-2-methylpropane-1-on, 1-hydroxy cyclohexyl phenyl ketone, 2-methyl-1-(4-methylthiophenyl)-2-morpholinopropane-1-on, 2-benzyl-2-dimethylamino-1-(4-morpholinophenyl)butane-1-on, 2-hydroxy-2-methyl-1-[4-(1-methylvinyl)phenyl]propane-1-on, 2-(4-methylbenzyl)-2-(dimethylamino)-1-(4-morpholino phenyl)butane-1-on, or the like.

Specific examples of the biimidazole compound may include 2,2′-bis(2-chlorophenyl)-4,4′,5,5′-tetraphenylbiimidazole, 2,2′-bis(2,3-dichlorophenyl)-4,4′,5,5′-tetraphenylbiimidazole, 2,2′-bis(2-chlorophenyl)-4,4′,5,5′-tetra(alkoxyphenyl)biimidazole, 2,2′-bis(2-chlorophenyl)-4,4′,5,5′-tetra(trialkoxyphenyl)biimidazole, 2,2-bis(2,6-dichlorophenyl)-4,4′5,5′-tetraphenyl-1,2′-biimidazole or an imidazole compound in which a phenyl group at 4,4′,5,5′-positions is substituted with carboalkoxylgroup, or the like.

A specific example of the oxime compound may include o-ethoxycarbonyl-α-oxyimino-1-phenylpropane-1-on, or the like.

In addition, other photopolymerization initiators, or the like, generally used in the art may also be additionally used as long as they do not damage an effect of the present invention. In addition, a mixture of the photopolymerization initiator and a photopolymerization initiation adjuvant generally used in the art may also be used.

### (d) Solvent

The solvent is not particularly limited. As the solvent, specifically, ethers, aromatic hydrocarbons, ketones, alcohols, esters, amides, or the like, may be used.

Specific examples of the solvent may include ethers such as ethyleneglycolmonomethylether, ethyleneglycolmonoethylether, ethyleneglycolmonopropylether, ethyleneglycolmonobutylether, diethyleneglycoldimethylether, diethyleneglycoldiethylether, diethyleneglycoldipropylether, diethyleneglycoldibutylether, or the like; aromatic hydrocarbons such as benzene, toluene, xylene, mesitylene, or the like; ketones such as methylethylketone, acetone, methylamylketone, methylisobutylketone, cyclohexanone, or the like; alcohols such as ethanol, propanol, butanol, hexanol, cyclohexanol, ethyleneglycol, glycerin or the like; esters such as 3-ethoxypropionic acid ethylester, 3-methoxy-propionic acid methylester, methyl-cellosolveacetate, ethylcellosolveacetate, ethylacetate, butylacetate, amylacetate, methyllactate, ethyllactate, butyllactate, 3-methoxy-butylacetate, 3-methyl-3-methoxy-1-butylacetate, methoxy-pentylacetate, ethyleneglycolmonoacetate, ethyleneglycoldiacetate, ethyleneglycolmonomethyletheracetate, ethyleneglycolmonoethyletheracetate, diethyleneglycolmonoacetate, diethyleneglycoldiacetate, diethyleneglycolmonobutyletheracetate, propyleneglycolmonoacetate, propyleneglycoldiacetate, propyleneglycolmonomethyletheracetate, propyleneglycolmonoethyletheracetate, ethylenecarbonate, propylenecarbonate, γ-butyrolactone, or the like. Among the solvents as described above, propyleneglycolmonomethyletheracetate, propyleneglycolmonoethyletheracetate, cyclohexanone, ethyllactate, butylacetate, 3-ethoxypropionic acid ethylester, 3-methoxy-propionic acid methylester, or the like, may be used with an application feature and a drying feature. Each of the solvents as described above may be used alone or as a mixture of two or more thereof.

### (e) Coloring Agent

The coloring agent may be a white pigment or a black pigment.

The white pigment, the coloring agent, may include TiO₂, and the black pigment, the coloring agent, may include carbon black.

The carbon black is not particularly limited, but may be, for example, graphitization carbon, furnace black, acetylene black, Ketjen Black, and the like.

Since TiO₂ is relatively inexpensive and has a high reflective index to have relatively high reflectivity, it may be used as an effective white coloring agent. Specifically, TiO₂ may have a rutile structure. Since TiO₂ having the rutile structure has an excellent whiteness index, it may be usefully used.

TiO₂, the white pigment, may be subjected to resin treatment, surface treatment using a pigment derivative, or the like, into which an acid group or a basic group is introduced, graft treatment on a pigment surface by a polymer compound, or the like, atomization treatment by a sulfuric acid atomization method, or the like, cleaning treatment by an organic solvent, water, or the like, for removing impurities, removal treatment of ionic impurities by an ion exchanging method, or the like, as needed.

Specifically, a surface of TiO₂ may be treated by at least one selected from a group consisting of SiO₂, Al₂O₃, and an organic material. The surface treatment of TiO₂ as described above may improve a reflective brightness feature while decreasing photocatalyst activity of TiO₂. Here, in TiO₂ of which the surface is treated, a content of TiO₂ core may be, specifically, in a range of 75 to 95 mass %. In the case in which the surface of the TiO₂ core is treated in the above-mentioned range, a whiteness index and reflective brightness are excellent.

### (f) Dispersant

The dispersing agent is added in order to maintain deagglomeration and stability of the white pigment and the black pigment, the coloring agents.

The dispersing agent may contain an acrylate-based dispersant including butylmethacrylate (BMA) or N,N-dimethylaminoethyl methacrylate (DMAEMA).

The dispersant may include a known resin type pigment dispersant, particularly, an oleaginous dispersant such as amide or salts thereof that are formed by reaction between polycarboxylic acid ester such as polyurethane and polyacrylate, unsaturated polyamide, polycarboxylic acid, (partial) amine salts of polycarboxylic acid, ammonium salts of polycarboxylic acid, alkylamine salts of polycarboxylic acid, polysiloxane, long-chain polyaminoamide phosphate salts, an ester of polycarboxylic acid containing hydroxyl group and a modified product thereof, or a polyester having a free carboxyl group and poly(lower alkyleneimine); a water-soluble resin or a water-soluble polymer compound such as (meth)acrylic acid-styrene copolymers, (meth)acrylic acid-(meth)acrylate ester copolymers, styrene-maleic acid copolymers, polyvinyl alcohol or polyvinyl pyrrolidone; a polyester; a modified polyacrylate; adducts of ethylene oxide/propylene oxide, and phosphate esters.

Particularly, in the case in which the pigment dispersant is used in the coloring agent, examples of the pigment dispersant may include a polyester-based polymer dispersant, an acryl based polymer dispersant, a phosphate ester-based dispersant, a polyurethane based polymer dispersant, a cationic surfactant, an anionic surfactant, a non-ionic surfactant, or the like. Each of the pigment dispersants as described above may be used alone or as a mixture of two or more thereof. A content of the pigment dispersant may be in a range of 1 to 100 parts by weight with respect to 100 parts by weight of a pigment and/or a dye. When the content of the pigment dispersant is in the above-mentioned range, a pigment in a uniform dispersed state may be obtained.

### (g) Additive Agent

The additive agent such as another polymer compound, a hardener, a surfactant, an adhesion promoter, an antioxidant, an ultraviolet (UV) absorber, an aggregation preventing agent, and the like, may also be added to the dispersant according to the embodiment of the present invention as needed.

Specific examples of another polymer compound may include a thermosetting resin such as an epoxy resin, a maleimide resin, or the like; or a thermoplastic resin such as polyvinyl alcohol, polyacrylic acid, polyethyleneglycolmonoalkylethers, polyfluoroalkylacrylate, polyester, polyurethane, or the like.

The hardener may be used in order to harden a core and improve mechanical strength thereof at the time of application to an electronic paper reflective plate using a photosensitive composition including the coloring agent dispersing composition according to the embodiment of the present invention. Specific examples of the hardener may include an epoxy compound, a polyfunctional isocyanate compound, a melamine compound, an oxetane compound, or the like.

Specific examples of the epoxy compound as the hardener may include a bisphenol A-based epoxy resin, a hydrogenated bisphenol A-based epoxy resin, a bisphenol F-based epoxy resin, a hydrogenated bisphenol F-based epoxy resin, a novolac type epoxy resin, another aromatic epoxy resin, a cycloaliphatic epoxy resin, a glycidylester based resin, a glycidylamine based resin, a brominated derivative thereof, aliphatic, cycloaliphatic, or aromatic epoxy compounds except for a epoxy resin and the brominated derivative of epoxy resin thereof, a butadiene(co)polymer epoxide, an isoprene(co)polymer epoxide, a glycidyl(meth)acrylate(co)polymer, triglycidylisocyanulate, or the like.

Specific examples of the oxetane compound as the hardener may include carbonatebisoxetane, xylenebisoxetane, adipatebisoxetane, terephthalatebisoxetane, cyclohexanedicarboxylic acid bisoxetane, or the like.

A hardening assisting compound capable of allowing epoxy group of the epoxy compound and a skeleton of the oxetane compound to be ring-opening polymerized may be used together with the hardener. Examples of the hardening assisting compound may include polycarboxylic acids, polycarboxylic acid anhydrides, acid generators, or the like. Each of the hardeners as described above may be used alone or as a mixture of two or more thereof.

As the surfactant, a fluorine based surfactant, a silicone based surfactant, or the like, may be used.

Specific examples of the adhesion promoter may include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, 3-isocyanatepropyltrimethoxysilane, 3-isocyanatepropyltriethoxysilane, or the like.

Specific examples of the antioxidant may include 2,2′-thio-bis(4-methyl-6-t-butylphenol), 2,6-di-t-butyl-4-methyl phenol, or the like.

Specific examples of the UV absorber may include 2-(3-tert-butyl-2-hydroxy-5-methylphenyl)-5-chlorobenzotria zole, alkoxybenzophenone, or the like.

A specific example of the aggregation preventing agent may include sodium polyacrylate, or the like.

Hereinafter, an Inventive Example will be provided in order to assist in the understanding of the present invention. However, the following Inventive Example is only an example of the present invention and various modifications and alterations may be made without departing from the scope and spirit of the present invention. In addition, these modifications and alterations will fall within the following claims.

### Inventive Example

A photosensitive resin composition was produced by mixing an alkali water-soluble binder resin (SUN3004 by Miwon Commercial Co., Ltd.) of 50 g, dipentaerythritol hexaacrylate (DPHA by Miwon Specialty Chemical. Co., Ltd.) of 40 g, a photoinitiator (Irgacure 819 by Ciba) of 5 g, a photoinitiator (Irgacure 184 by Ciba) of 5 g, and a PGMEA of 300 g with one another. The photosensitive resin composition was spin-coated on a glass substrate at 1000 rpm for 30 seconds to form a first photosensitive resin layer. The first photosensitive resin layer was heated at a temperature of 100° C. for 5 minutes to remove a solvent.

In order to produce a TiO₂ photosensitive resin composition, a dispersant of BYK180 of 2% and a binder resin of 2% with respect to TiO₂ were dissolved in propyleneglycolmonomethylethyletheracetate (PGMEA), TiO₂ was added thereto such that concentration of the composition becomes 60%, and the composition was then dispersed using a bead mill for one hour. This dispersing liquid was mixed with the photosensitive resin composition to produce the TiO₂ photosensitive resin composition. This composition was composed of TiO₂ of 45%, the photosensitive resin composition of 15%, and PGMEA of a remaining percentage. This composition was spin-coated on the first photosensitive resin layer at 700 rpm for 30 seconds to form a white layer. Then, the white layer was heated at a temperature of 100° C. for 5 minutes to remove a solvent.

A photomask was put on the first photosensitive resin layer and was irradiated with ultraviolet rays. In this case, a high pressure mercury lamp of 1 KW containing all of g, h, and i lines was used as an ultraviolet light source to irradiate the ultraviolet rays at illumination of 150 mJ/cm². A developing machine was used to perform development at a development temperature of 25° C. for a development time of 60 seconds, for a washing time of 60 seconds, and spin-dry for 25 seconds. In this case, a potassium hydroxide aqueous solution having 1 wt % concentration was used as a developer.

### Comparative Example

Processes other than a process of forming a first photosensitive resin layer were performed the same as those of Inventive Example described above.

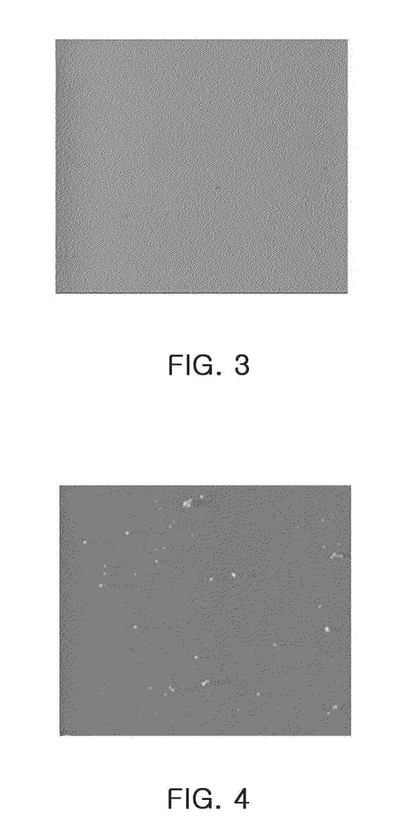

Results obtained by observing surfaces of the glass substrates manufactured according to Inventive Example and Comparative Example after development using a scanning electronic microscope (SEM) are shown in FIGS. 3 and 4. As seen in FIG. 3, in the case in which the first photosensitive resin layer is applied, a TiO₂ residue was not observed. However, as seen in FIG. 4, in the case in which the first photosensitive resin layer is not applied, particles remaining on the surface were observed.

As set forth above, according to the embodiments of the present invention, a residue phenomenon in which pigment particles included in the bezel remain on a surface of the glass substrate after exposure and development may be prevented.

While the present invention has been shown and described in connection with the embodiments, it will be apparent to those skilled in the art that modifications and variations can be made without departing from the spirit and scope of the invention as defined by the appended claims.

What is claimed is:

1. A touch screen module comprising:
a glass substrate;
a first photosensitive resin layer formed on the glass substrate and a bezel including a second photosensitive resin layer formed on the first photosensitive resin layer; and
transparent electrodes simultaneously formed on both the glass substrate and the bezel.

2. The touch screen module of claim 1, wherein the transparent electrode includes at least one selected from a group consisting of silver (Ag), gold (Au), copper (Cu), aluminum (Al), indium tin oxide (ITO), and a conductive polymer.

3. The touch screen module of claim 2, wherein the silver (Ag) is a silver salt including gelatin.

4. The touch screen module of claim 1, wherein the first photosensitive resin layer is formed by a spin coating method or a slit coating method.

5. The touch screen module of claim 1, wherein the second photosensitive resin layer is formed by the spin coating method or the slit coating method.

6. The touch screen module of claim 1, wherein the second photosensitive resin layer includes a pigment.

7. The touch screen module of claim 6, wherein the pigment is titanium dioxide (TiO₂) or carbon black.

8. A method of manufacturing a touch screen module, the method comprising:
preparing a glass substrate;
forming a first photosensitive resin layer on the glass substrate and forming a bezel including a second photosensitive resin layer on the first photosensitive resin layer; and
simultaneously forming transparent electrodes on both the glass substrate and the bezel.

9. The method of claim 8, wherein the transparent electrode includes at least one selected from a group consisting of silver (Ag), gold (Au), copper (Cu), aluminum (Al), indium tin oxide (ITO), and a conductive polymer.

10. The method of claim 9, wherein the silver (Ag) is a silver salt including gelatin.

11. The method of claim 8, wherein the first photosensitive resin layer is formed by a spin coating method or a slit coating method.

12. The method of claim 8, wherein the second photosensitive resin layer is formed by the spin coating method or the slit coating method.

13. The method of claim 8, wherein the second photosensitive resin layer includes a pigment.

14. The method of claim 13, wherein the pigment is titanium dioxide (TiO₂) or carbon black.
